(19) United States
(12) Patent Application Publication
(10) Pub. No.: US 2025/0288934 A1
(43) Pub. Date: Sep. 18, 2025

(54) COOKING APPARATUS VENTILATION SYSTEM INCLUDING OIL-SMOKE COLLECTION FILTER

(71) Applicant: SAMSUNG ELECTRONICS CO., LTD., Suwon-si (KR)

(72) Inventors: Kiyoshi IWAMOTO, Yokohama-shi (JP); Kenichi MURATA, Yokohama-shi (JP)

(73) Assignee: SAMSUNG ELECTRONICS CO., LTD., Suwon-si (KR)

(21) Appl. No.: 19/225,371

(22) Filed: Jun. 2, 2025

Related U.S. Application Data
(63) Continuation of application No. PCT/KR2023/016385, filed on Oct. 20, 2023.

(30) Foreign Application Priority Data
Dec. 7, 2022 (JP) 2022-195405

(51) Int. Cl. B01D 46/52; A47J 36/38; B01D 39/16; B01D 46/00; F24F 13/28

(52) U.S. Cl. CPC B01D 46/521; A47J 36/38; B01D 39/1623; B01D 46/0047; F24F 13/28; B01D 2239/0435; B01D 2239/0457; B01D 2239/0618; B01D 2239/1233; B01D 2239/1291; B01D 2273/30; B01D 2275/205; B01D 2277/20; B01D 2279/35

(57) ABSTRACT

An oil smoke collection filter of a cooking apparatus ventilation system including a nonwoven fabric having a pleated structure such that a ridge fold part located on a wind-upstream side along the first direction and a valley fold part located on a wind-downstream side along the first direction are alternately arranged along a second direction that is orthogonal to the first direction. The nonwoven fabric includes a ventilation part configured to connect the ridge fold part and the valley fold part to each other and be obliquely arranged with respect to the first direction, and an inclination angle of the ventilation part with respect to the first direction is maintained even when a position of the ventilation part along the first direction changes.

### CROSS-REFERENCE TO RELATED APPLICATION(S)

This application is a continuation application, claiming priority under § 111(a), of International Application No. PCT/KR2023/016385, filed on Oct. 20, 2023, which is based on and claims the benefit of Japanese Patent Application No.: 2022-195405, filed Dec. 7, 2022, in the Japanese Intellectual Property Office, the disclosures of which are incorporated by reference herein in their entireties.

### TECHNICAL FIELD

The present disclosure relates to an oil smoke collection filter and a ventilation system including the same.

### BACKGROUND ART

It is predicted that the future form of the kitchen will be mainstream with the introduction of an island-type ventilation system that allows cooking while facing the family.

Because changing the layout into an island-type ventilation system requires large-scale piping system construction, it has the merit of being able to freely change the layout by simplifying the installation by making it ductless instead of discharging oil smoke (i.e., oil fume or soot) during cooking through a duct installed at a predetermined position.

A ventilation system supporting the ductless trend is configured to remove oil smoke from inhaled air and return the resulting air to the indoor space. Accordingly, in order to prevent the oil smoke from spreading into the indoor space or a deodorization filter from being clogged by the oil smoke, the development of an oil smoke collection filter for collecting the oil smoke is urgently required to improve the quality of the future residential environment.

For example, it may be attempted to apply an air cleaner filter disclosed in Patent Document 1 to an oil smoke collection filter. The air cleaner filter is a pleats-type filter that is pleat-processed, and has the advantage of being able to achieve a large filtration area.

However, because an air cleaner pleats-type filter is intended to collect cigarette smoke, dust, or the like, simply using the air cleaner pleats-type filter as an oil smoke collection filter is unpractical due to its high frequency of replacement due to clogging.

### PRIOR ART DOCUMENTS

### Patent Documents

[Patent Document 1] Japanese Patent Application Publication No. 2007-190518.

### DISCLOSURE OF INVENTION

### Solution to Problem

A cooking apparatus ventilation system according to an embodiment of the present disclosure may be a cooking apparatus ventilation system for removing oil smoke from air occurring due to use of a cooking apparatus, and may include a fan configured to guide air along a first direction, and an oil smoke collection filter configured to collect oil smoke from the air moving along the first direction.

The oil smoke collection filter may include a nonwoven fabric having a pleated structure such that a ridge fold part located on a wind-upstream side along the first direction and a valley fold part located on a wind-downstream side along the first direction are alternately arranged along a second direction that is orthogonal to the first direction.

The nonwoven fabric may include a ventilation part configured to connect the ridge fold part and the valley fold part to each other and be obliquely arranged with respect to the first direction.

An inclination angle of the ventilation part with respect to the first direction may be maintained even when a position the ventilation part along the first direction changes.

An oil smoke collection filter according to an embodiment of the present disclosure may be a filter for collecting oil smoke contained in air moving in a first direction, and may include a nonwoven fabric having a pleated structure such that a ridge fold part located on a wind-upstream side in the first direction and a valley fold part located on a wind-downstream side in the first direction are alternately arranged in a second direction orthogonal to the first direction.

The nonwoven fabric may include a ventilation part configured to connect the ridge fold part and the valley fold part to each other and obliquely arranged with respect to the first direction.

An inclination angle of the ventilation part with respect to the first direction may be maintained even when a position in the first direction changes in the ventilation part.

### BRIEF DESCRIPTION OF DRAWINGS

FIG. 1 is a schematic diagram illustrating the exterior of a ventilation system according to an embodiment of the present disclosure.

FIG. 2 is a schematic diagram illustrating a configuration of a ventilation system in an embodiment of the present disclosure.

FIG. 3 is a schematic diagram illustrating a configuration of an oil smoke collection filter in an embodiment of the present disclosure.

FIG. 4 is a cross-sectional view illustrating a configuration of an oil smoke collection filter in an embodiment of the present disclosure.

FIG. 5 is a cross-sectional view illustrating a detailed configuration of an oil smoke collection filter in an embodiment of the present disclosure.

FIG. 6 is a schematic diagram illustrating a mechanism of oil smoke collection by an oil smoke collection filter in an embodiment of the present disclosure.

FIG. 7 is a diagram illustrating a method of measuring the mass collection efficiency of oil smoke in an embodiment of the present disclosure.

FIG. 8 is a graph illustrating the relationship between the basis weight for each resin fiber diameter before oil smoke collection and the collection efficiency, the pressure loss, and the performance index (initial performance) in an embodiment of the present disclosure.

FIG. 9 is a graph illustrating the relationship between the thickness of a filter material before oil smoke collection and the collection efficiency, the pressure loss, and the oil smoke collection capacity (initial performance) and the relationship between the thickness of a filter material for each resin fiber diameter and the performance after 60 g oil smoke collection (oil smoke collection capacity) in an embodiment of the present disclosure.

FIG. 10 is a graph illustrating the relationship between the filter material fiber diameter and the filter performance (oil smoke collection capacity) after 60 g oil smoke collection for each filter material thickness in an embodiment of the present disclosure.

### MODE FOR THE INVENTION

Hereinafter, an oil smoke collection filter according to the present disclosure and an embodiment of a ventilation system including the oil smoke collection filter will be described with reference to the drawings.

### Configuration of Ventilation System 1000

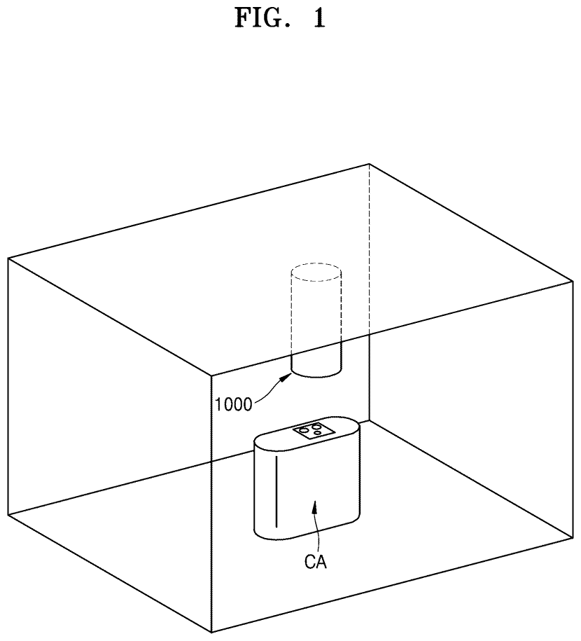

Referring to FIG. 1, a ventilation system according to the present embodiment may be a cooking apparatus ventilation system 1000 (hereinafter referred to as ‘ventilation system 1000’) for removing oil smoke from air containing oil smoke generated when using a cooking apparatus CA. For example, the ventilation system 1000 may be used when using the cooking apparatus CA that heats food. For example, the ventilation system 1000 may be used in an island-type kitchen.

For example, the ventilation system 1000 may be used in a ductless kitchen. For example, the ventilation system 1000 may be configured to inhale oil smoke occurring during cooking, pass the oil smoke through an oil smoke collection filter 100, and then return air with the oil smoke removed therefrom to the indoor space.

The ventilation system 1000 may be arranged over or under the cooking apparatus CA to inhale oil smoke generated when using the cooking apparatus CA. The ventilation system 1000 may be arranged to overlap the cooking apparatus CA in a vertical direction. At least a portion of the ventilation system 1000 may be arranged to overlap the cooking apparatus CA in the vertical direction. For example, the ventilation system 1000 may be arranged over the cooking apparatus CA and may be spaced apart from the cooking apparatus CA in the vertical direction.

Although FIG. 1 illustrates the ventilation system 1000 that inhales oil smoke upward, the ventilation system 1000 may also be a downdraft-type ventilation system that inhales oil smoke downward. Also, the ventilation system 1000 according to the present disclosure is not necessarily limited to being used in a ductless kitchen and may be used to pass the inhaled oil smoke through the oil smoke collection filter 100 and then discharge the collected oil smoke to the outdoor space.

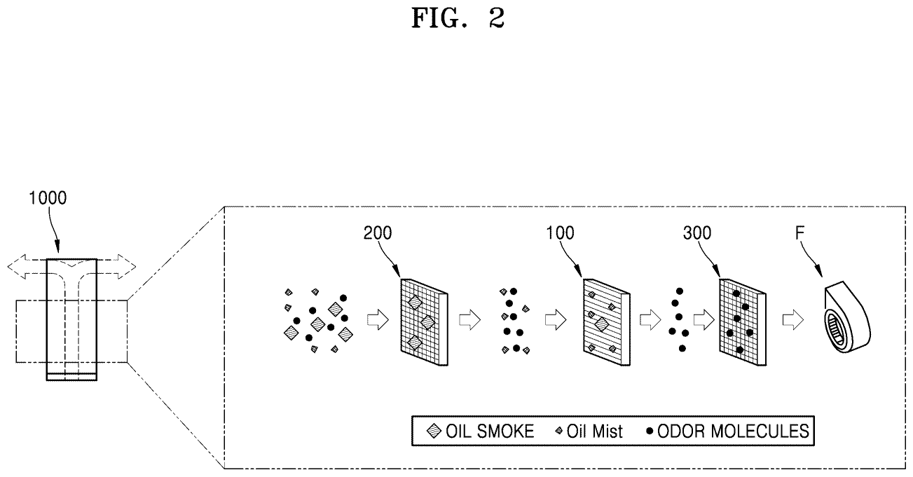

Referring to FIG. 2, the ventilation system 1000 according to an embodiment may inhale air containing oil smoke from the indoor space and return the air with the oil smoke removed therefrom to the indoor space. As an example for this, the ventilation system 1000 may include a fan F configured to induce an air flow in a first direction and an oil smoke collection filter 100 configured to collect oil smoke contained in air moving in the first direction. Here, the oil smoke may include oil fume and oil mist.

The fan F may perform a function of inducing an air flow such that indoor air is introduced into the ventilation system 1000 and the introduced indoor air passes through the oil smoke collection filter 100 and then is discharged back to the indoor space. For example, the fan F may be arranged to discharge the air that has passed through the oil smoke collection filter 100, from the downstream in the first direction of the oil smoke collection filter 100 toward the indoor space.

The ventilation system 1000 according to an embodiment may further include at least one of a mesh filter 200 and a deodorization filter 300. The ventilation system 1000 according to an embodiment may include the mesh filter 200 and the deodorization filter 300. In the direction of the air flow, the mesh filter 200, the oil smoke collection filter 100, the deodorization filter 300, and the fan F may be sequentially arranged.

The mesh filter 200 may have a coarser mesh size than the oil smoke collection filter 100 arranged downstream. The oil smoke collection filter 100 may have a finer mesh size than the mesh filter 200. The deodorization filter 300 may have a finer mesh size than the mesh filter 200. The deodorization filter 300 may have a finer mesh size than the oil smoke collection filter 100.

However, the configuration of the ventilation system 1000 is not limited thereto and may be suitably modified.

### Configuration of Oil Smoke Collection Filter 100

Because the ventilation system 1000 of the present embodiment is characterized in the oil smoke collection filter 100, the oil smoke collection filter 100 will be described below in detail.

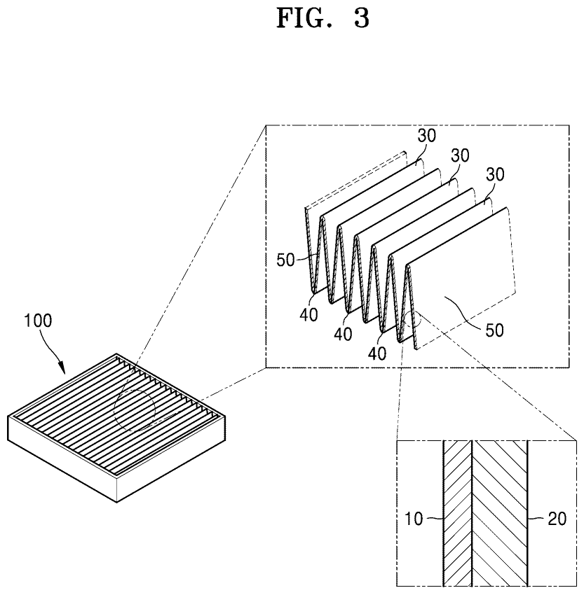

Referring to FIG. 3, the oil smoke collection filter 100 according to an embodiment may collect oil smoke and may be a pleats-type filter formed by pleating a nonwoven fabric. The oil smoke collection filter 100 may have a structure in which the nonwoven fabric is pleated. The oil smoke collection filter 100 may have a frame that supports a frame of the pleated nonwoven fabric.

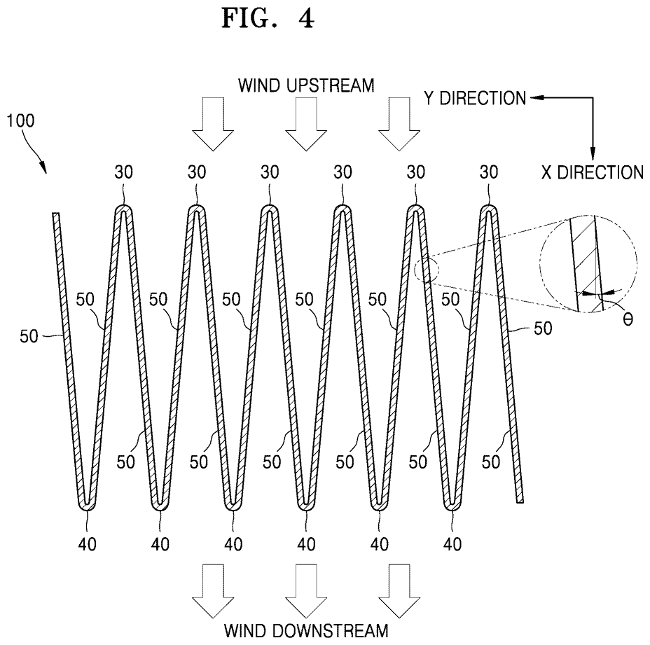

Particularly, as illustrated in FIGS. 3 and 4, in the oil smoke collection filter 100, a ridge fold part 30 located on a wind-upstream side in a first direction (X direction) and a valley fold part 40 located on a wind-downstream side in the first direction (X direction) may be alternately formed in a second direction (Y direction) orthogonal to the first direction. In this configuration, an area located between the ridge fold part 30 and the valley fold part 40 adjacent to each other may function as a ventilation part 50 through which wind mainly passes. In other words, the oil smoke collection filter 100 may include a ventilation part 50 connecting the ridge fold part 30 and valley fold part 40 to each other.

The ventilation part 50 may be obliquely arranged with respect to the first direction (X direction). The ventilation part 50 may have an inclination angle θ with respect to the first direction (X direction).

The inclination angle θ of the ventilation part 50 with respect to the first direction (X direction) may be maintained even when the position in the first direction (X direction) changes in the ventilation part 50. In other words, the oil smoke collection filter 100 may be configured such that the curvature of the ventilation part 50 is small.

When the curvature of the ventilation part 50 formed between the ridge fold part 30 and the valley fold part 40 is small, the oil smoke may not be easily adhered to the ventilation part 50 and thus the oil component may be collected mainly by the valley fold part 40. As a result, the oil smoke may be collected while avoiding an increase in the pressure loss of the ventilation part 50. Accordingly, the oil smoke collection filter 100 may not be easily clogged, and thus, even when used for a long period, a decrease in the wind volume or a decrease in the oil smoke collection rate due to an increase in the pressure loss may be suppressed.

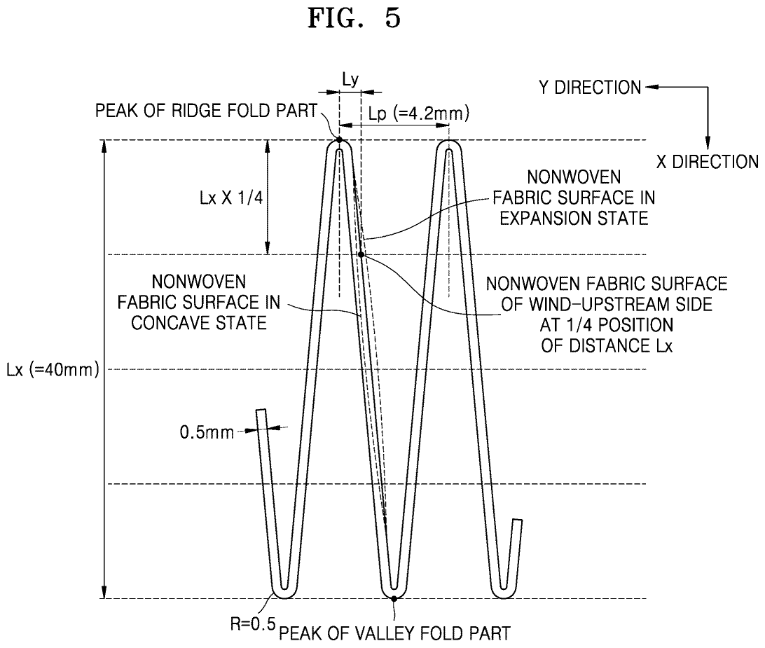

Referring to FIG. 5, as an example of the configuration for this, the oil smoke collection filter 100 may be configured such that, with respect to a distance Lx from a peak of the ridge fold part 30 to a peak of the valley fold part 40 in the X direction, at a position at ¼ of the distance Lx from the peak of the ridge fold part 30 in the X direction, a distance Ly between a nonwoven fabric surface (e.g., the surface of a filter material layer 10) on the wind-upward side and the peak of the ridge fold part 30 in the Y direction may be 17% to 25% of the distance (pitch Lp) between the peaks of the ridge fold parts 30 adjacent to each other in the Y direction. Also, the particular dimensions illustrated in FIG. 5 are just examples and the prevent disclosure is not limited to these dimensions.

The nonwoven fabric may include a filter material layer 10 including a filter material, and an aggregate layer 20 including an aggregate that supports the filter material layer 10. The nonwoven fabric may have a structure in which the filter material layer 10 and the aggregate layer 20 are attached and laminated to each other. The filter material layer 10 and the aggregate layer 20 may have a pleated structure.

A fiber diameter of a resin fiber constituting the filter material may be 3.5 μm to 6.0 μm. Here, the fiber diameter of the resin fiber may be an average fiber diameter.

By using the resin fiber with a fiber diameter of 3.5 μm to 6.0 μm, rigidity may be given to the resin fiber constituting the filter material. Through the resin fiber having rigidity, even when oil smoke collection is performed, an adhesion between the resin fibers may be prevented and thus and a gap between the resin fibers may be secured. As a result, the long-term service life and low pressure loss of the oil smoke collection filter may be compatible with each other. In contrast, when the diameter of the resin fiber of the filter material is small, for example, 2 μm or less, the original shape of the resin fiber may collapse with the progression of the collection of the oil smoke, and accordingly, the gap between the resin fibers may be blocked.

The thickness of the filter material layer 10 may be 0.2 mm to 0.3 mm. The thickness of the nonwoven fabric may be the sum of the thickness of the filter material layer 10 and the thickness of the aggregate layer 20. The thickness of the nonwoven fabric may be at least two times the thickness of the filter material layer 10. The thickness of the nonwoven fabric may be 0.5 mm to 0.6 mm. The thickness of the aggregate layer 20 may be greater than or equal to the thickness of the filter material layer 10. The thickness of the aggregate layer 20 may be, for example, 0.3 mm. Here, the thickness may be defined as the thickness in a direction perpendicular to the surface of each layer.

As such, by reducing the thickness of the filter material layer 10 and the thickness of the nonwoven fabric, the oil smoke collection filter 100 may be folded such that the ridge fold part 30 and the valley fold part 40 have a sharp shape. By using the ridge fold part 30 and the valley fold part 40 having a sharp shape, the ventilation resistance may be reduced and the filter may not be easily compressed and deformed even when a large amount of wind passes therethrough. Also, the curvature of the ventilation part 50 formed between the ridge fold part 30 and valley fold part 40 may be reduced, and thus, the area where air stagnates around the ventilation part 50 may be reduced. As a result, the cohesion of the oil smoke may be suppressed and simultaneously the blockage in the ventilation part may be prevented.

As an example, when the fiber diameter of the resin fiber constituting the filter material is 3.5 μm to 6.0 μm, the thickness of the filter material layer 10 is 0.2 mm to 0.3 mm, and the thickness of the nonwoven fabric is 0.5 mm to 0.6 mm, as described above, at a position at ¼ of the distance Lx from the peak of the ridge fold part 30, the distance Ly between the nonwoven fabric surface on the wind-upward side and the peak of the ridge fold part 30 in the Y direction may be 17% to 25% of the distance (pitch Lp) between the peaks of the ridge fold part 30.

The basis weight of the filter material layer 10 may be 20 g/m² to 90 g/m². The material of the filter material layer 10 may be polypropylene (PP). However, the material of the filter material layer 10 is not limited thereto and may be an oil-repellent resin such as a silicon-based resin or a fluorine-based resin such as polytetrafluoroethylene (PTFE).

The fiber diameter of the resin fiber constituting the aggregate may be greater than the fiber diameter of the resin fiber constituting the filter material. For example, the fiber diameter of the resin fiber constituting the aggregate may be greater than 3 times the fiber diameter of the resin fiber constituting the filter material. For example, the fiber diameter of the resin fiber constituting the aggregate may be greater than 5 times the fiber diameter of the resin fiber constituting the filter material. For example, the fiber diameter of the resin fiber constituting the aggregate may be greater than 6 times the fiber diameter of the resin fiber constituting the filter material. However, the fiber diameter of the resin fiber constituting the aggregate may be 20 times or less the fiber diameter of the resin fiber constituting the filter material. For example, the fiber diameter of the resin fiber constituting the aggregate may be 37 μm.

The basis weight of the aggregate layer 20 may be 20 g/m² to 90 g/m². For example, the basis weight of the aggregate layer 20 may be 47 g/m². Also, the material of the aggregate layer 20 may be, for example, polyethylene terephthalate (PET). However, the material of the aggregate layer 20 is not limited thereto and may be variously modified.

The amount of oil smoke that may be collected by the oil smoke collection filter 100 may be proportional to the filter expansion area. The oil smoke collection filter 100 according to an embodiment may have a large filter expansion area. For example, a filter expansion area D (m²) may be 0.8 or more. Moreover, the filter expansion area D (m²) may be 10 or less. As described above, by increasing the filter expansion area of the oil smoke collection filter 100, the service life of the oil smoke collection filter 100 may be extended. Here, the filter expansion area may be the area of the pleated nonwoven fabric in an unfolded state. For example, the oil smoke collection filter 100 may be configured such that the filter expansion area D (m²) is great in comparison with a filter volume V (m³). For example, a D/V representing the ratio of the filter expansion area D (m²) to the filter volume V (m³) may be 400 or more, and the filter expansion area D (m²) may be 0.8 or more. As described above, by increasing the filter expansion area of the oil smoke collection filter 100, the service life of the oil smoke collection filter may be extended. Also, by configuring the filter expansion area D (m²) to be greater than the filter volume V (m³), the oil smoke collection filter 100 may be miniaturized while extending its service life. Moreover, the D/V representing the ratio of the filter expansion area D (m²) to the filter volume V (m³) may be 10,000 or less. The filter expansion area D (m²) may be 10 or less. Here, the filter volume may be the volume occupied by the oil smoke collection filter 100 including the pleated nonwoven fabric.

In the present embodiment, the nonwoven fabric may be configured to be sharply folded at the valley fold part 40. When the fiber diameter of the resin fiber constituting the filter material is 4.0 μm to 6.0 μm, the thickness of the filter material layer is 0.2 mm to 0.3 mm, and the thickness of the nonwoven fabric is 0.5 mm to 0.6 mm, D/V may be 400 or more and D may be 0.8 or more as described above. For example, the curvature radius of the valley fold part 40 may be a certain size or less. For example, the curvature radius of the valley fold part 40 may be 0.6 mm or less. For example, the curvature radius of the valley fold part 40 may be 0.5 mm or less. The curvature radius of the valley fold part 40 may be less than or equal to the thickness of the nonwoven fabric. For example, when the thickness of the nonwoven fabric is 0.5 mm, the curvature radius of the valley fold part 40 may be 0.5 mm.

### Effects of Present Embodiments

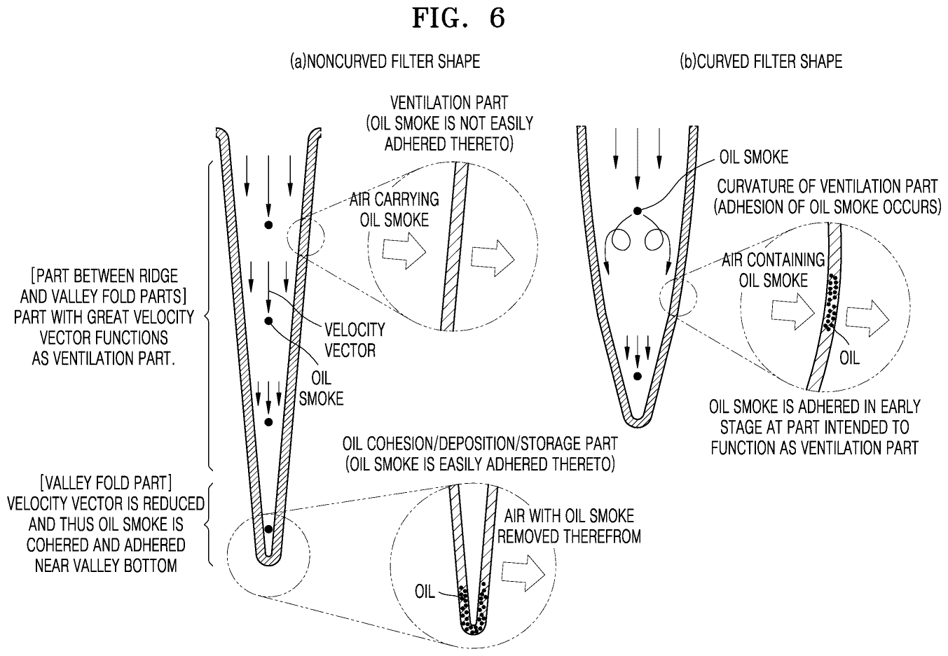

According to the oil smoke collection filter 100 configured as such, as illustrated in FIG. 6(a), because the curvature of the ventilation part 50 formed between the ridge fold part 30 and the valley fold part 40 is small, the oil smoke may not be easily adhered to the ventilation part 50 and thus the oil component may be collected mainly by the valley fold part 40. The oil smoke contained in the air may move in a direction toward the valley fold part 40 and the velocity vector thereof may decrease in the valley fold part 40 and thus the oil smoke may be cohered. In this case, the air or wind carrying the oil smoke may pass through the oil smoke collection filter 100 in the process of moving to the valley fold part 40. As a result, the oil smoke may be collected while avoiding an increase in the pressure loss of the ventilation part 50. Accordingly, the oil smoke collection filter 100 may not be easily clogged, and thus, even when used for a long period, a decrease in the wind volume or a decrease in the oil smoke collection rate due to an increase in the pressure loss may be suppressed. As illustrated in FIG. 6(b), when the ventilation part 50 is curved, the oil smoke may be easily adhered to the ventilation part 50 and thus may be easily clogged, and when used for a long period, the pressure loss may increase, thus causing a decrease in the wind volume or a decrease in the oil smoke collection rate.

### Design and Simulation Result of Oil Smoke Collection Filter

The particle diameters of oil smoke particles to be collected by the oil smoke collection filter are mostly 1 μm or more.

The oil smoke collection filter of the present embodiment may use a collection mechanism of “blocking” and “inertial collision” to efficiently collect particles with a diameter of 1 μm or more. The following points may be considered as a design for increasing the frequency of blocking and inertial collision.

(1) Increase the basis weight

(2) Increase the thickness of the filter material layer

(3) Increase the resin fiber diameter of the filter material

In verifying the design for the above points (1) to (3), because there is no filter index indicating the oil smoke collection capacity, the following oil smoke collection capacity is defined as an index for determining whether the high oil smoke purification capacity is maintained without a decrease in the wind volume due to an increase in the pressure loss caused by oil smoke blockage.

$$Oil smoke collection capacity ( C M H ) = Oil smoke mass collection efficiency ( wt \% / 100 ) \times Wind volume ( Cubic Meter Hour ( C M H ) )$$

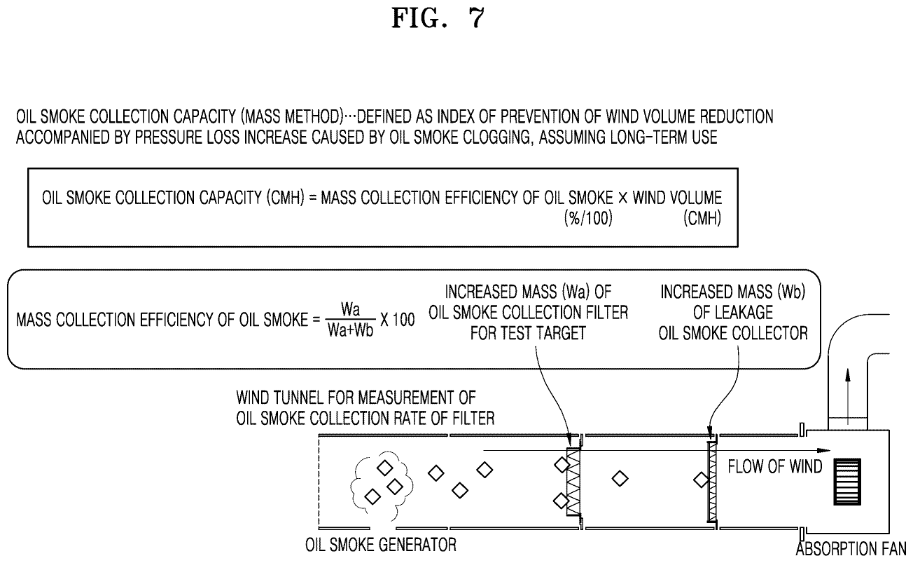

Also, the oil smoke mass collection efficiency (wt %/100) is measured by a method illustrated in FIG. 7. Particularly, an oil smoke generator, an oil smoke collection filter for a test target, a missing oil smoke collector (filter), and an inhalation fan are arranged from the upstream side, and an increased mass (Wa) of the oil smoke collection filter for the test subject and an increased mass (Wb) of the missing oil smoke collector are obtained. Then, the oil smoke mass collection efficiency is obtained by {Wa/(Wa+Wb)}×100.

A standard oil smoke collection capacity for a long-life oil smoke collection filter that may maintain low pressure loss and high collection even when the oil smoke collection progresses is set to 395 CMH or more when 60 g oil smoke is collected. Also, 60 g is an oil smoke generation amount equivalent to 1 year.

### (1) Review of Basis Weight

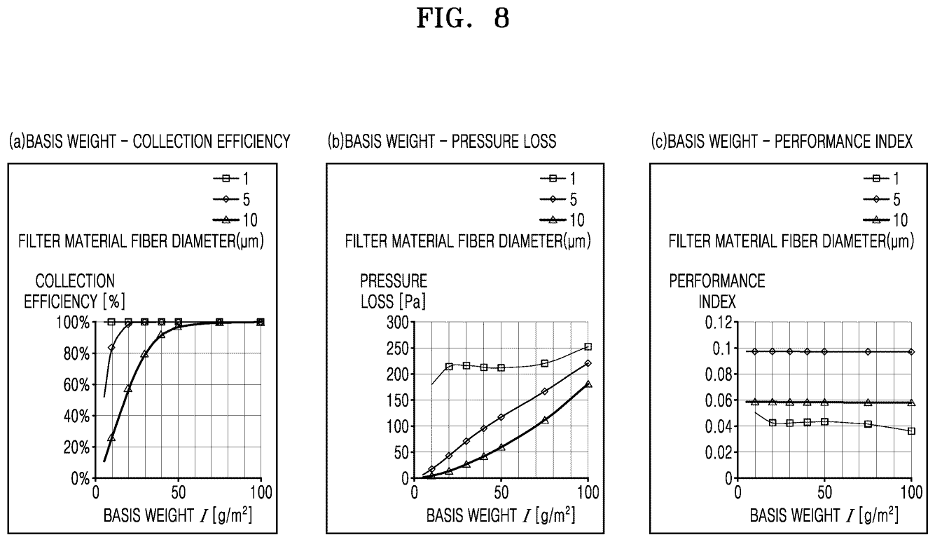

The basis weight (g/m²) for each resin fiber diameter before oil smoke collection and the relationship between the collection efficiency (%) and the pressure loss (Pa) (initial performance) are illustrated in FIG. 8.

### Conditions

FIG. 8 illustrates the simulation results and actual measurements when the size of the oil smoke collection filter is 200 mm frame (thickness: 40 mm), the thickness of the filter material layer is 0.2 mm, and the oil smoke particle diameter is 5 μm.

The relationship used in the simulation is as follows.

$$Collection efficiency ( E ) = 1 - exp ( - 4 \cdot α \cdot D \cdot {η}^{f} / ( π \cdot ( 1 - α ) \cdot {d}_{f} \cdot ( 1 + σ ) ) )$$

$$Pressure loss ( Δ p ) = ( 16 / {k}^{f} ) \cdot ( μ \cdot α \cdot U \cdot D / ( ( 1 - α ) \cdot {d}_{f} \cdot {d}_{f} \cdot ( 1 + σ ) ) )$$

$$Performance index ( Qf ) = - ln ( 1 - E / 100 ) / p$$

α: charging rate, D: thickness of filter material layer, η^{f}: single fiber collection efficiency, π: circular constant,

d_{f}: resin fiber diameter, k^{t}: hydraulic factor, μ: air viscosity, U: airflow velocity, σ: fiber diameter dispersion

### Consideration

In the design of the oil smoke collection filter based on the assumption of collecting oil smoke particles, a performance index (Qf) for the basis weight calculated from the collecting efficiency and the pressure loss for each resin fiber diameter of the filter material does not show a significant difference for the same resin fiber diameter in the range of the basis weight of 20 g/m² to 90 g/m². For example, in the oil smoke collection filter whose resin fiber diameter of the filter material is 1μm, the performance index is maintained at about 0.04 even when the basis weight changes in the range of 20 g/m² to 90 g/m². For example, in the oil smoke collection filter whose resin fiber diameter of the filter material is 10μm, the performance index is maintained at about 0.06 even when the basis weight changes in the range of 20 g/m² to 90 g/m². For example, in the oil smoke collection filter whose resin fiber diameter of the filter material is 5μm, the performance index is maintained at about 0.1 even when the basis weight changes in the range of 20 g/m² to 90 g/m².

Based on the performance index (Qf) for each resin fiber diameter of the filter material, for the resin fiber diameters of 1μm, 5μm, and 10μm, the performance index is high for a resin fiber diameter of 5μm.

### (2) Review of Thickness of Filter Material Layer

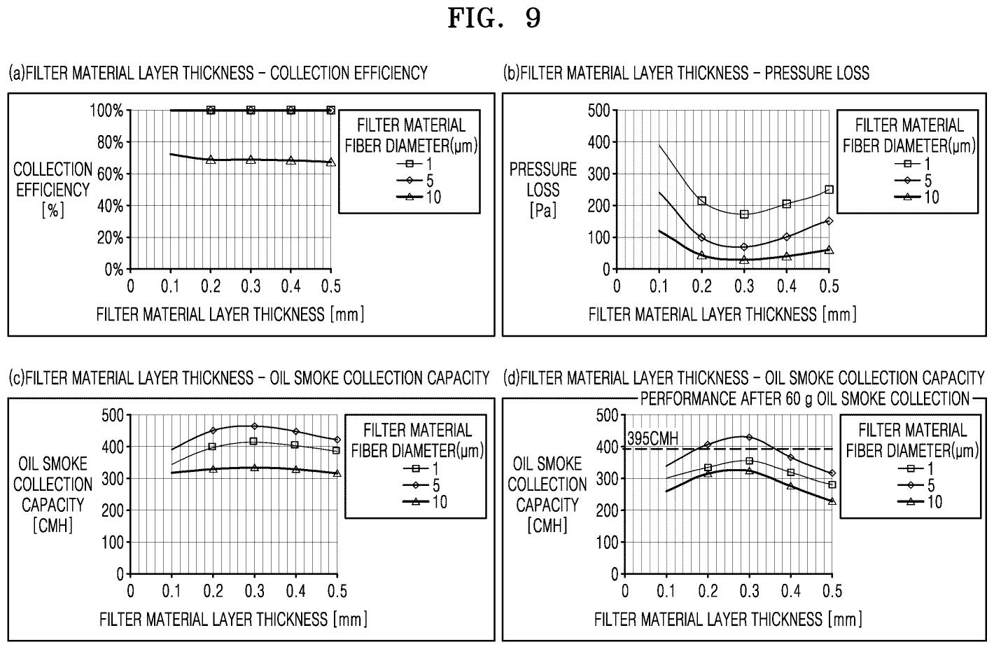

The relationship between the thickness (mm) of the filter material layer before oil smoke collection and the collection efficiency (%), the pressure loss (Pa), and the oil smoke collection capacity (CMH) (initial performance) is illustrated in FIG. 9.

### Conditions

FIG. 9 illustrates the simulation results and actual measurements when the size of the oil smoke collection filter is 200 mm frame (thickness: 40 mm), the basis weight is 40 g/m², and the oil smoke particle diameter is 5 μm.

The relationship used in the simulation is as follows.

$$Collection efficiency ( E ) = 1 - exp ( - 4 \cdot α \cdot D \cdot {η}^{f} / ( π \cdot ( 1 - α ) \cdot {d}_{f} \cdot ( 1 + σ ) ) )$$

$$Pressure loss ( Δ p ) = ( 16 / {k}^{f} ) \cdot ( μ \cdot α \cdot U \cdot D / ( ( 1 - α ) \cdot {d}_{f} \cdot {d}_{f} \cdot ( 1 + σ ) ) )$$

$$Oil smoke collection capacity ( C M H ) = Oil smoke mass collection efficiency ( wt \% / 100 ) \times Wind volume ( C M H )$$

### Consideration

Referring to FIG. 9(a), even when the thickness of the filter material layer is changed while the basis weight is fixed, the collection efficiency is uniform for each resin fiber diameter. Referring to FIGS. 9(b) and 9(c), when the thickness of the filter material layer is changed while the basis weight is fixed, the pressure loss and the oil smoke collection capacity are different for each resin fiber diameter. For example, when the thickness of the filter material layer is too small or too great while the basis weight is fixed, the pressure loss increases and the oil smoke collection capacity decreases.

The graph of the filter material layer thickness for each resin fiber diameter with the basis weight fixed and the performance (oil smoke collection capacity) after 60 g (equivalent to 1 year) oil smoke collection is illustrated in FIG. 9(d). From this graph, it may be seen that the performance of 395 CMH or more is achieved when the thickness of the filter material layer is in the range of 0.2 mm to 0.3 mm.
The reason why the performance may not be achieved when the thickness of the filter material layer is too small:

It is considered that, when the thickness of the filter material layer is small with the same basis weight, the wind path between the resin fibers is blocked and thus the ventilation resistance increases and the pressure loss increases.
The reason why the performance may not be achieved when the thickness of the filter material layer is too great:

It is considered that, when the thickness of the filter material layer is great as 0.4 mm or more with the same basis weight, the oil smoke collection filter is not sharply folded when pleat-processed, and thus, the ventilation resistance increases from the initial stage before the accumulation of oil smoke and thus the pressure loss increases. Particularly, in the case of an oil smoke collection filter for food, the passing wind velocity is great and thus the oil smoke collection filter may be compressed and deformed and thus the pressure loss increases.

### (3) Review of Resin Fiber Diameter of Filter Material

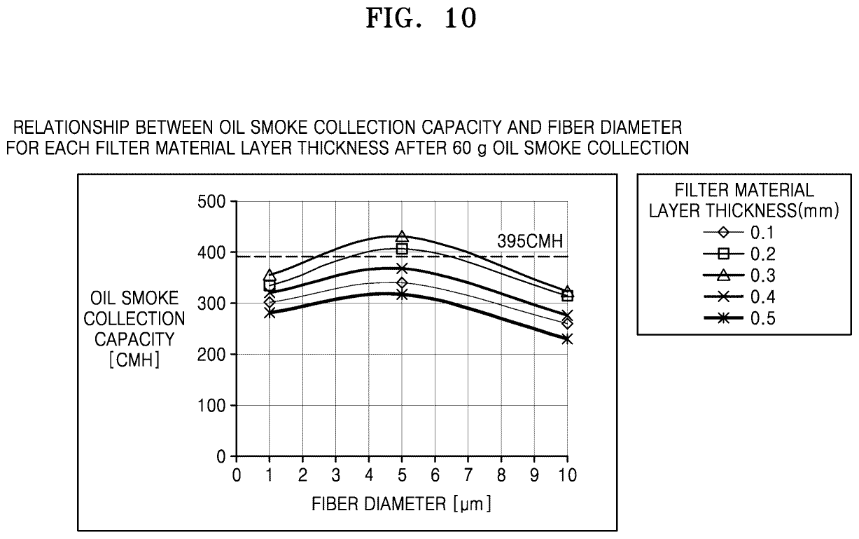

The simulation results and actual measurements for the filter material fiber diameter (μm) and the filter performance (oil smoke collection capacity) for each filter material layer thickness after 60 g oil smoke collection are illustrated in FIG. 10.

Even after 60 g oil smoke is adhered thereto, the high filter performance is maintained as the oil smoke collection filter in the following range.

When the filter material layer thickness is 0.2 mm to 0.3 mm, the resin fiber diameter is about 3.5 μm to about 6.0 μm.

(When the filter material layer thickness is 0.3 mm, the resin fiber diameter is about 2.5 μm to about 7 μm.)

(When the filter material layer thickness is 0.2 mm, the resin fiber diameter is about 3.5 μm to about 6 μm.)

### Reasons

(a) It is considered that, by using a filter material of thick resin fibers (4.0 μm to 6.0 μm), by giving rigidity to the filter material fibers, a gap between the fibers may be secured and an adhesion between the resin fibers may be prevented even when the oil smoke collection progresses.

(b) It is considered that, by making the filter material layer thin (0.2 mm to 0.3 mm), a sharp shape is formed when pleat-processed, and thus the ventilation resistance decreases and the oil smoke collection filter is not easily compressed and deformed even when a large amount of wind passes therethrough.

(c) It is considered that, by making the filter material layer thin, the ventilation part between the ridge fold part and the valley fold part may not be easily curved, and thus, a stagnant air area may not be formed and the clogging by the oil smoke may be prevented by suppressing the cohesion of the oil smoke.

### Modified Embodiments

Also, the present disclosure is not limited to the above embodiments.

For example, at least one of the filter material and the aggregate may be electret-processed. For example, the filter material may be electret-processed. Also, the aggregate may be electret-processed like the filter material. By electret-processing at least one of the filter material and the aggregate, the collection efficiency of the oil smoke collection filter may be improved.

For example, at least one of the filter material and the aggregate may be flame retardant-processed. For example, the filter material may be flame retardant-processed. Also, the aggregate may be flame retardant-processed like the filter material. By flame retardant-processing at least one of the filter material and the aggregate, the stability of the oil smoke collection filter may be improved.

Also, an oil storage part having a smaller gap size than the ventilation part may be installed in the valley fold part. It is conceivable that this oil storage part is formed by pressing and denting the valley bottom of the valley fold part in the second direction (Y direction). With this configuration, by using the valley fold part, which is difficult in functioning as a ventilation part due to a small velocity vector of passing wind, as an oil storage part, a wide area with a large velocity vector may be used as a ventilation part, and thus, the pressure loss at the initial stage of use may be suppressed. Also, because a portion of the passing wind stays in the valley fold part, the amount of deposition of the oil component contained in the smoke may also increase and thus the oil component collection efficiency may also be improved.

Also, although the above embodiment has described the case where the oil smoke collection filter 100 is applied to the ventilation system 1000, the oil smoke collection filter 100 according to the present disclosure may also be used in an air cleaner. That is, an air cleaner including the oil smoke collection filter 100 according to the present disclosure may also be an embodiment of the present disclosure.

Also, the present disclosure is not limited to the above embodiments, and various modifications may be made therein without departing from the spirit and scope of the present disclosure.

A cooking apparatus ventilation system including the oil smoke collection filter according to an embodiment of the present disclosure may collect oil smoke generated during cooking and may not be easily clogged, thus suppressing a decrease in the wind volume or a decrease in the oil smoke collection rate due to an increase in the pressure loss even when used for a long period.

A cooking apparatus ventilation system according to an embodiment of the present disclosure may be a cooking apparatus ventilation system for removing oil smoke from air containing oil smoke occurring when using a cooking apparatus, and may include a fan configured to induce an air flow in a first direction, and an oil smoke collection filter configured to collect oil smoke contained in air moving in the first direction.

The oil smoke collection filter may include a nonwoven fabric having a pleated structure such that a ridge fold part located on a wind-upstream side in the first direction and a valley fold part located on a wind-downstream side in the first direction are alternately arranged in a second direction orthogonal to the first direction.

The nonwoven fabric may include a ventilation part configured to connect the ridge fold part and the valley fold part to each other and obliquely arranged with respect to the first direction.

An inclination angle of the ventilation part with respect to the first direction may be maintained even when a position in the first direction changes in the ventilation part.

The nonwoven fabric may be configured such that, at a position at ¼ of a distance from a peak of the ridge fold part to a peak of the valley fold part in the first direction, a distance between a nonwoven fabric surface on the wind-upward side and the peak of the ridge fold part in the second direction is 17% to 25% of a distance between peaks of the ridge fold parts adjacent to each other in the second direction.

The nonwoven fabric may include a filter material layer including a filter material configured to collect oil smoke, and an aggregate layer including an aggregate configured to support the filter material layer.

A fiber diameter of a resin fiber constituting the filter material may be 3.5 μm to 6.0 μm.

A thickness of the filter material layer may be 0.2 mm to 0.3 mm.

A thickness of the nonwoven fabric may be 0.5 mm to 0.6 mm.

A D/V representing a ratio of a filter expansion area D (m²) to a filter volume V (m3) may be 400 or more.

A basis weight of the filter material may be 20 g/m² to 90 g/m².

At least one of the filter material and the aggregate may be electret-processed.

At least one of the filter material and the aggregate may be flame retardant-processed.

The cooking apparatus ventilation system may be configured to inhale oil smoke, pass the oil smoke through the oil smoke collection filter, and return air with the oil smoke removed therefrom to an indoor space.

The cooking apparatus ventilation system may be arranged to overlap the cooking apparatus in a vertical direction.

An oil smoke collection filter according to an embodiment of the present disclosure may be a filter for collecting oil smoke contained in air moving in a first direction, and may include a nonwoven fabric having a pleated structure such that a ridge fold part located on a wind-upstream side in the first direction and a valley fold part located on a wind-downstream side in the first direction are alternately arranged in a second direction orthogonal to the first direction.

The nonwoven fabric may include a ventilation part configured to connect the ridge fold part and the valley fold part to each other and obliquely arranged with respect to the first direction.

An inclination angle of the ventilation part with respect to the first direction may be maintained even when a position in the first direction changes in the ventilation part.

The nonwoven fabric may be configured such that, at a position at 1/4 of a distance from a peak of the ridge fold part to a peak of the valley fold part in the first direction, a distance between a nonwoven fabric surface on the wind-upward side and the peak of the ridge fold part in the second direction is 17% to 25% of a distance between peaks of the ridge fold parts adjacent to each other in the second direction.

The nonwoven fabric may include a filter material layer including a filter material configured to collect oil smoke, and an aggregate layer including an aggregate configured to support the filter material layer.

A fiber diameter of a resin fiber constituting the filter material may be 3.5 μm to 6.0 μm.

A thickness of the filter material layer may be 0.2 mm to 0.3 mm, and a thickness of the nonwoven fabric may be 0.5 mm to 0.6 mm.

A D/V representing a ratio of a filter expansion area D (m²) to a filter volume V (m³) may be 400 or more.

A basis weight of the filter material may be 20 g/m² to 90 g/m².

At least one of the filter material and the aggregate may be electret-processed.

At least one of the filter material and the aggregate may be flame retardant-processed.

1. A cooking apparatus ventilation system for removing oil smoke from air occurring due to use of a cooking apparatus, the cooking apparatus ventilation system comprising:
a fan configured to guide air along a first direction; and
an oil smoke collection filter configured to collect oil smoke from the air moving along the first direction,
wherein the oil smoke collection filter comprises a nonwoven fabric having a pleated structure such that a ridge fold part located on a wind-upstream side along the first direction and a valley fold part located on a wind-downstream side along the first direction are alternately arranged along a second direction that is orthogonal to the first direction,
the nonwoven fabric comprises a ventilation part configured to connect the ridge fold part and the valley fold part to each other and be obliquely arranged with respect to the first direction, and
an inclination angle of the ventilation part with respect to the first direction is maintained even when a position of the ventilation part along the first direction changes.

2. The cooking apparatus ventilation system of claim 1, wherein the nonwoven fabric is configured to be at a position at ¼ of a distance from a peak of the ridge fold part to a peak of the valley fold part along the first direction, and
a distance between a nonwoven fabric surface on the wind-upstream side and the peak of the ridge fold part along the second direction is 17% to 25% of a distance between peaks of ridge fold parts adjacent to each other in the second direction.

3. The cooking apparatus ventilation system of claim 2, wherein the nonwoven fabric comprises:
a filter material layer comprising a filter material configured to collect oil smoke; and
an aggregate layer comprising an aggregate configured to support the filter material layer.

4. The cooking apparatus ventilation system of claim 3, wherein a fiber diameter of a resin fiber constituting the filter material is 3.5 μm to 6.0 μm.

5. The cooking apparatus ventilation system of claim 3, wherein a thickness of the filter material layer is 0.2 mm to 0.3 mm.

6. The cooking apparatus ventilation system of claim 3, wherein a thickness of the nonwoven fabric is 0.5 mm to 0.6 mm.

7. The cooking apparatus ventilation system of claim 1, wherein a D/V representing a ratio of a filter expansion area D (m²) to a filter volume V (m³) is 400 or more.

8. The cooking apparatus ventilation system of claim 3, wherein a basis weight of the filter material is 20 g/m² to 90 g/m².

9. The cooking apparatus ventilation system of claim 3, wherein at least one of the filter material and the aggregate is electret-processed.

10. The cooking apparatus ventilation system of claim 3, wherein at least one of the filter material and the aggregate is flame retardant-processed.

11. The cooking apparatus ventilation system of claim 1, wherein the cooking apparatus ventilation system is configured to inhale oil smoke, pass the oil smoke through the oil smoke collection filter, and return air with the oil smoke removed therefrom to an indoor space.

12. An oil smoke collection filter for collecting oil smoke contained in air moving in a first direction, the oil smoke collection filter comprising a nonwoven fabric having a pleated structure such that a ridge fold part located on a wind-upstream side in the first direction and a valley fold part located on a wind-downstream side in the first direction are alternately arranged in a second direction orthogonal to the first direction,
wherein the nonwoven fabric comprises a ventilation part configured to connect the ridge fold part and the valley fold part to each other and obliquely arranged with respect to the first direction, and
an inclination angle of the ventilation part with respect to the first direction is maintained even when a position in the first direction changes in the ventilation part.

13. The oil smoke collection filter of claim 12, wherein the nonwoven fabric is configured such that, at a position at ¼ of a distance from a peak of the ridge fold part to a peak of the valley fold part in the first direction, a distance between a nonwoven fabric surface on the wind-upstream side and the peak of the ridge fold part in the second direction is 17% to 25% of a distance between peaks of ridge fold parts adjacent to each other in the second direction.

14. The oil smoke collection filter of claim 13, wherein the nonwoven fabric comprises:
a filter material layer comprising a filter material configured to collect oil smoke; and
an aggregate layer comprising an aggregate configured to support the filter material layer,
wherein a fiber diameter of a resin fiber constituting the filter material is 3.5 μm to 6.0 μm.

15. The oil smoke collection filter of claim 14, wherein a thickness of the filter material layer is 0.2 mm to 0.3 mm, and
a thickness of the nonwoven fabric is 0.5 mm to 0.6 mm.
